(19) United States
(12) Patent Application Publication
(10) Pub. No.: US 2012/0012796 A1
(43) Pub. Date: Jan. 19, 2012

(54) CONDUCTIVE FILMS BASED ON GRAPHENE AND PROCESS FOR PREPARING THE SAME

(76) Inventors: Yongsheng Chen, Tianjin (CN); Yi Huang, Tianjin (CN); Lu Huang, Tianjin (CN)

(21) Appl. No.: 13/144,603

(22) PCT Filed: Jan. 15, 2010
(86) PCT No.: PCT/CN2010/070203

§ 371 Date: Oct. 3, 2011

(30) Foreign Application Priority Data
Jan. 16, 2009 (CN) 200910067703

(51) Int. Cl. H01B 1/04; B05D 3/10; B05D 1/18; B05D 3/12; B05D 3/02; B05D 5/12; B05D 1/02; B82Y 99/00

(52) U.S. Cl. 252/502; 427/122; 977/734

(57) ABSTRACT

The present invention is directed to a process for preparing a conductive film comprising: 1) coating a solution comprising functionalized graphene on the surface of a substrate to form a film; and 2) chemically reducing and/or calcining the film, which is loaded on the matrix material and obtained in step 1). The process can be used to prepare a conductive film on various substrates, such as steel, glass, ceramic, quartz, carbon materials, silicon materials, and organic materials.

### TECHNICAL FIELD

The present invention is directed to the field of carbon materials, in particular to a conductive film based on graphene and a process for preparing the same.

### BACKGROUND ART

Carbon film is a film material which is widely used in the fields of machines, electronics, construction, medical care, and the like. At present, the most interested carbon film materials comprise diamond films and amorphous carbon films, and the like.

In general, most of diamond films and amorphous carbon films are prepared by the methods of chemical vapor deposition (CVD) or physical vapor deposition (PVD). If such two films are grown on various substrate materials, the substrate materials must be placed in special devices. Moreover, the substrate materials must bear the special conditions such as arc, plasma, high temperature, high pressure, high vacuum, and the like as needed during vapor deposition. Therefore, it is quite difficult to apply these methods for preparing carbon films on substrate materials with poor stability (e.g. polymer). In addition, it is quite difficult to prepare carbon films on substrate materials with large size or complex shapes due to the chamber volume of the devices.

### SUMMARY OF INVENTION

In one aspect, the present invention provides a process for preparing a conductive film comprising:

1) coating a solution comprising functionalized graphene on the surface of a substrate to form a film; and

2) chemically reducing and/or calcining the film which is coated on the substrate and obtained in step 1).

In another aspect, the present invention provides a conductive film obtained with the above process.

### BRIEF DESCRIPTION OF DRAWINGS

FIG. 1 is an optical photograph of a quartz sheet coated with graphene films.

FIG. 2 is an optical photograph of a glass sheet coated with graphene films.

FIG. 3 is an optical photograph of a polyimide film coated with graphene films.

FIG. 4 is an optical photograph of a silicon sheet coated with graphene films.

### DETAIL DESCRIPTION OF INVENTION

Graphene is a novel two-dimensional nano carbon material consisting of one layer of carbon atoms. The strength of graphene is the highest among the known materials. Furthermore, the conductive capacity and carrier density of graphene are better than those of the single-walled carbon nanotubes which are known as the best at present. The good quantum Hall effect of grapheme has been proved. Graphene is widely concerned due to the excellent conductivity as well as good physical and chemical stability thereof.

In one aspect, the present invention provides a process for preparing a conductive film comprising:
1) coating a solution comprising functionalized graphene on the surface of a substrate to form a film; and
2) chemically reducing and/or calcining the film which is coated on the substrate and obtained in step 1).

The term “graphene” as used in the present invention refers to a two-dimensional planar material, of which the molecular backbone consists of carbon atoms arranged in hexagonal lattice. Single graphene sheet has an area of 10 nm² to 400 μm². The graphene used in the present invention is a single-layer or few-layer graphene, in which the single-layer graphene has a thickness of 0.34 nm to 1.4 nm, while the few-layer graphene has 2 to 5 layers and a thickness of 0.7 nm to 7 nm.

It should be appreciated by a person having ordinary skill in the art that the layer number of few-layer graphene is the statistically significant layer number. When the layer number of a few-layer graphene is referred to as a certain number or a numeric range, it is not indicated that the few-layer graphene only comprises the graphene layers with this layer number or numeric range. When the layer number of a few-layer graphene is referred to as a certain number or a numeric range in the present invention, the layer number or numeric range of the graphene layers contained in the few-layer graphene is at least 50% of the total weight of the few-layer graphene, preferably at least 60%, more preferably at least 70%, and even more preferably at least 80%.

In a specific embodiment of the present invention, the functionalized graphene is prepared with graphite as raw materials by chemical oxidation. A chemically oxidized graphene can comprise functional groups such as carboxyl, hydroxyl, epoxy bond, ether bond, carbonyl and the like in the edge. The presence of the functional groups imparts some solubility to the graphene, such that the graphene can dissolve or homogeneously disperse in water or other aqueous solvents.

In another specific embodiment of the present invention, the functionalized graphene is prepared by reacting a chemically oxidized graphene with an organic functionalized reagent. In one specific embodiment, the organic functionalized regent as used herein is an isocyanate compound. The isocyanate compounds having different structures react with the active groups such as hydroxyl, carboxyl and the like in the chemically oxidized graphene. Different organic functional groups are introduced in the structure of a graphene, such that the graphene can readily dissolve or homogeneously disperse in an organic solvent.

The isocyanate compound, which can be used in the present invention includes, but is not limited to, a mono-isocyanate compound and a diisocyanate compound. The mono-isocyanate compound includes, but is not limited to, phenyl isocyanate, tert-butyl isocyanate, cyclohexane isocyanate, hexane isocyanate, cyanophenyl isocyanate, acetylphenyl isocyanate, and isocyanatobenzene sulfonate azide. The diisocyanate compounds include, but are not limited to, toluene diisocyanate (TDI), methylenediphenyl diisocyanate (MDI), 1,6-hexamethylene diisocyanate (HDI), isophorone diisocyanate (IPDI), and hydrogenated methylenediphenyl diisocyanate (HMDI).

In one specific embodiment of the present invention, the solvent used in the solution includes water and an organic solvent, in which the organic solvent includes, but is not limited to, N,N-dimethyl formamide (DMF), ethanol, benzene, dichlorobenzene, tetrahydrofuran and/or acetonitrile and the like.

In one specific embodiment of the invention, the solution of the functionalized graphene has a concentration of 0.1 to 10 mg/mL.

In one specific embodiment of the present invention, the coating process includes, but is not limited to, immersing, spin coating, spraying and casting.

In one specific embodiment of the present invention, the substrate is selected from steel, glass, ceramics, quartz, carbon materials, silicon materials and/or organic materials.

In another specific embodiment, the organic materials are selected from polyurethane, polyacrylate, polyester, polyamide, ABS, polyolefin, polycarbonate, polyvinyl chloride, polyimide, epoxy resin, phenolic resin and/or rubber.

In one specific embodiment of the present invention, where the substrate is an organic material and the solution comprising functionalized graphene is an aqueous solution, the process further comprises, before the step 1), activating the surface of the organic material and strengthening the hydrophilicity of the surface of the organic material. In a preferred embodiment of the invention, the activating step comprises immersing the substrate in a concentrated sulfuric acid or coating polystyrene imine and sodium polystyrene sulfonate on the surface of the substrate.

In the process for preparing a conductive film according to the present invention, chemical reduction and/or calcination can be used to completely or partly eliminate the functional groups or the defects of the graphene so as to restore the structure and properties (including conductivity, thermal conductivity, mechanical properties, and the like) of the graphene. In the process according to the present invention, the chemical reduction and calcination can be used alone or in combination with each other.

In one specific embodiment of the present invention, a reducing agent is selected from hydrazine, hydrazine hydrate, dimethylhydrazine and/or borohydride such as sodium borohydride and potassium borohydride.

In one specific embodiment of the present invention, the chemical reduction is to stream with hydrazine dydrate.

In one specific embodiment of the present invention, the calcination is carried out in vacuo.

In another specific embodiment of the present invention, the calcination is carried out under inert gas atmosphere, such as nitrogen, argon, helium, and the like.

In another aspect, the present invention provides a conductive film obtained by the above process. The conductive film has the excellent conductivity and mechanical strength.

In yet another aspect, the present invention provides a process for changing the surface properties of a substrate, in which the process comprises forming a conductive film on the surface of the substrate according to the process of any one of claims 1-14. After forming the conductive film on the surface, the surface of the substrate has the excellent conductivity and mechanical strength.

The invention will be specifically described by the following examples. It should be appreciated that the examples are only used to further illustrate the invention and should not be construed to limit the scope of the invention. A person having ordinary skill in the art can make some nonessential improvements and adjustments according to the above disclosure of the present invention, all of which belong to the scope of protection of the present invention.

### Example 1

### Conductive Films Based on Single-Layer Graphene

Chemical oxidation was used to prepare functionalized single-layer graphene. To a flask were added 10 g of graphite and 7 g of sodium nitrate (analytical pure), and then was added 500 mL of concentrated sulfuric acid (analytical pure). In an ice-water bath, to the flask was slowly added 40 g of potassium permanganate with stirring. The period duration for adding potassium permanganate was 2 h, and then the resultant mixture was kept for 2 h and cooled to the ambient temperature. The mixture was stirred for 10 days at the ambient temperature. The reaction solution became green, then dark brown, and finally brick brown. Moreover, the reaction solution became viscous. To 1000 mL of 5 wt % diluted sulfuric acid was added the reaction solution with continuously stirring at 98° C. The period duration for adding the reaction solution was 2 h. The reaction solution was stirred for further 2 h at 98° C., and then cooled to 60° C. To the solution was added 30 mL of hydrogen peroxide (30% aqueous solution). The resultant mixture was kept for 2 h at 60° C., and then cooled to the ambient temperature and stirred for 2 h.

To remove the ions, especially manganese ions, introduced with oxidizing materials, centrifugation was used to remove the impurities in the reaction solution. Centrifugation was carried out at 4000 rpm for 10 min. The supernatant was removed. To the resultant solids was added 2 L of a mixture of 3 wt % concentrated sulfuric acid/0.5 wt % hydrogen peroxide. The resultant mixture was vigorously stirred and ultrasonically treated in a water bath at 200 W for 30 min. The above procedure was repeated for 15 times. 3 wt % of hydrochloric acid was used to repeat the above procedure for 3 times. Distilled water was used to repeat the above procedure for 1 time. The reaction solution was transferred in acetone and the remaining acid was removed. Finally, after drying functionalized single-layer graphene was obtained in the yield of 70%. The functionalized single-layer graphene comprises organic functional groups such as hydroxyl, carboxy and epoxy bonds and the like. The mass percentage of the functional groups was 20%.

To water was added 1 g of the functionalized single-layer graphene. The resultant mixture was ultrasonically treated at 500 W for 30 min to completely disperse. The dispersion was sprayed on the surface of a cleaned glass substrate (10×10 cm) to form a film. After placing at the ambient temperature for 48 h, the glass substrate was immersed in pure hydrazine for 24 h so as to obtain a reduced single-layer graphene conductive film.

The above dispersion of functionalized single-layer graphene was used to form films on substrates such as steel plate, iron plate, ceramic sheet, quartz sheet, organic films (including polyurethane, polyester, polyamide, ABS, polyethylene, polypropylene, polycarbonate, polyvinyl chloride, polyimide, epoxy resin, phenolic resin or rubber and the like) by spin coating. Reduced single-layer graphene conductive films coated on different substrates were obtained by the same reduction process.

The characterization results of carbon films prepared by this process are listed in Table 1.

TABLE 1

| | Thickness of | | | |
|---|---|---|---|---|
| | Single-layer | | Scratch | |
| | Graphene | | Resis- | Conductivity |
| Substrates | Carbon Films | Appearance | tance | (S/cm) |
| Glass Plate | 1 μm | Gray, | Good | 5 × 10⁻¹ |
| | | Translucent | | |
| Steel Plate | 1 μm | Gray, | Good | Substrate is |
| | | Translucent | | Conductive |
| Iron Plate | 1 μm | Gray, | Good | Substrate is |
| | | Translucent | | Conductive |
| Quartz Sheet | 1 μm | Gray, | Good | 5 × 10⁻¹ |
| | | Translucent | | |
| Ceramic Sheet | 10 μm | Gray, | Good | 6 × 10⁻¹ |
| | | Translucent | | |
| Polyurethane | 10 μm | Gray, | Good | 6 × 10⁻¹ |
| Film | | Translucent | | |
| Polyester Film | 10 μm | Gray, | Good | 6 × 10⁻¹ |
| | | Translucent | | |
| Polyamide Film | 10 μm | Gray, | Good | 6 × 10⁻¹ |
| | | Translucent | | |
| ABS Film | 10 μm | Gray, | Good | 6 × 10⁻¹ |
| | | Translucent | | |
| Polyethylene | 10 μm | Gray, | Good | 6 × 10⁻¹ |
| Film | | Translucent | | |
| Polypropylene | 10 μm | Gray, | Good | 6 × 10⁻¹ |
| Film | | Translucent | | |
| Polyvinyl | 100 μm | Black, | Good | 6 × 10⁻¹ |
| Chloride Film | | Opaque | | |
| Polyimide Film | 100 μm | Black, | Good | 6 × 10⁻¹ |
| | | Opaque | | |
| Epoxy Resin | 100 μm | Black, | Good | 6 × 10⁻¹ |
| Sheet | | Opaque | | |
| Phenolic Resin | 100 μm | Black, | Good | 6 × 10⁻¹ |
| Sheet | | Opaque | | |
| Rubber Sheet | 100 μm | Black, | Good | 6 × 10⁻¹ |
| | | Opaque | | |

### Example 2

### Transparent Conductive Films Based on Single-Layer Graphene

A functionalized single-layer graphene was prepared according to the process described in Example 1. To water was added 1 g of functionalized single-layer graphene. The resultant mixture was ultrasonically treated at 500 W for 30 min to completely disperse.

Films were formed on the surface of cleaned quartz sheets (20×20×1 mm) with the above dispersion of functionalized single-layer graphene by spin coating. The films were placed at the ambient temperature for 48 h. The single-layer graphene films coated on quartz sheets were placed in an airtight device and were streamed with hydrazine hydrate (98%, Alfa Aesar) for 24 h, so as to obtain single-layer graphene films reduced with hydrazine dreams.

The single-layer graphene films reduced with hydrazine streams was placed in a tubular furnace and calcined for 3 h at 400° C. under nitrogen atmosphere to obtain transparent conductive single-layer graphene carbon films.

Alternatively, the single-layer graphene films reduced with hydrazine streams were calcined for 1 h at 1000° C. in vacuo (10⁻⁵ Torr) to obtain transparent conductive single-layer graphene carbon films.

The characterization results of carbon films prepared by the process according to the present example are listed in Table 2.

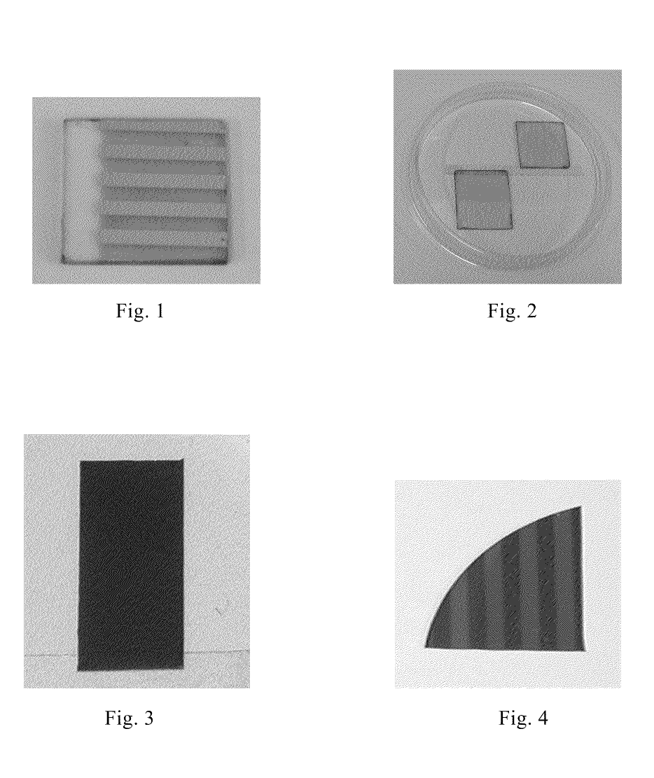

FIG. 1 is an optical photograph of a quartz sheet coated with graphene films (the gray section is coated with graphene films and is plated with gold electrodes to test the conductivity. The width of electrodes and the space between the electrodes are 2 mm).

TABLE 2

| | Thickness of | | Visible | |
|---|---|---|---|---|
| | Single-layer | | Light | |
| Calcination | Graphene | | Transmit- | Conductivity |
| Conditions | Carbon Films | Appearance | tance (%) | (S/cm) |
| 400° C./ | 5 nm | Colorless, | 90 | 2 × 10² |
| nitrogen | | Transparent | | |
| atmosphere | | | | |
| 400° C./ | 10 nm | Colorless, | 60 | 2 × 10² |
| nitrogen | | Translucent | | |
| atmosphere | | | | |
| 400° C./ | 20 nm | Colorless, | 40 | 3 × 10² |
| nitrogen | | Translucent | | |
| atmosphere | | | | |
| 1000° C./ | 20 nm | Colorless, | 40 | 2 × 10³ |
| in vacuo | | Translucent | | |

### Example 3

### Conductive Films Based on Few-Layer Graphene

To 1 L of three-neck flask with round bottom were added 5.0 g of graphite and 3.75 g of NaNO₃, and then was slowly added 190 ml of concentrated sulfuric acid with stirring. After homogeneously mixed, 11.25 g of KMnO₄ solid was slowly added. The resultant mixture was kept in an ice-water bath for 3 h to cool to the ambient temperature. After stirring for 6 days at the ambient temperature, 500 ml of distilled water was slowly dropwise added in the reaction system. The mixture reacted for 3 h at 95-98° C. The reaction solution was cooled. 15 ml of hydrogen peroxide (30 wt % aqueous solution) was added to the reaction solution. The resultant mixture was stirred at the ambient temperature. The impurities in the reaction solution were removed according to the centrifugation process which is similar to that of Example 1 to obtain a product of an aqueous solution of few-layer graphene. A few-layer graphene product having 2-5 layers was obtained by removing the solvent of water.

To water was added 1 g of the above few-layer grapheme. The resultant mixture was ultrasonically treated at 500 W for 60 min to completely disperse. 0.5 g of sodium borohydride was added and the mixture was stirred and reacted for 2 h at 80° C. The solution became from brown to black and a reduced few-layer graphene dispersion was obtained.

Films were formed on the surface of cleaned glass substrate (10×10 cm) with the above graphene dispersion by casting. The films were placed at the ambient temperature for 48 h. The graphene films coated on glass substrates were calcined for 3 h at 400° C. under nitrogen atmosphere to obtain conductive few-layer graphene carbon films with conductivity of 2×10² S/cm.

### Example 4

### Materials Coated with Conductive Films Based on Single-Layer Graphene

A functionalized single-layer graphene was prepared according to the process of Example 1. To water was added 1 g of functionalized single-layer graphene. The resultant mixture was ultrasonically treated at 500 W for 30 min to completely disperse.

The silicon nitride ceramics was immersed in an aqueous solution of single-layer graphene for 10 min and placed for 48 h at the ambient temperature after taken out. The ceramics was placed in an airtight device and dreamed for 24 h with hydrazine hydrate (80%. Alfa Aesar). Under nitrogen atmosphere, the ceramics was calcined for 2 h at 400° C. to obtain silicon nitride ceramics of which the surface was coated with functionalized single-layer graphene conductive films.

With the same process, alumina ceramics, alloy steel, tool steel, pig iron, quartz, glass, silicon piece and polyimide film materials, of which the surface was coated with functionalized single-layer graphene conductive films, were prepared. The materials and the characterization thereof are listed Table 3.

FIG. 2 is an optical photograph of a glass sheet coated with graphene films. FIG. 3 is an optical photograph of a polyimide film coated with graphene films. FIG. 4 is an optical photograph of a silicon sheet coated with graphene films (which was plated with gold electrodes to test the conductivity. The width of the electrodes and the space between the electrodes are 2 mm).

TABLE 3

| | | | Scratch | |
|---|---|---|---|---|
| | Thickness of | Appearance | Resis- | Conductivity |
| Substrates | coatings (nm) | of Coatings | tance | (S/cm) |
| Silicon Nitride | 5 | Colorless, | Good | 2 × 10² |
| Ceramics | | Transparent | | |
| Alumina | 5 | Colorless, | Good | Substrate is |
| Ceramics | | Transparent | | Conductive |
| Alloy Steel | 4 | Colorless, | Good | Substrate is |
| 20CrMnsi | | Transparent | | Conductive |
| Tool Steel | 4 | Colorless, | Good | Substrate is |
| SKH52 | | Transparent | | Conductive |
| Pig Iron | 4 | Colorless, | Good | Substrate is |
| | | Transparent | | Conductive |
| Quartz Sheet | 5 | Colorless, | Good | 2 × 10² |
| | | Transparent | | |
| Glass Sheet | 5 | Colorless, | Good | 2 × 10² |
| | | Transparent | | |
| Silicon Sheet | 10 | Translucent | Good | 2 × 10² |
| Polyimide | 10 | Translucent | Good | 2 × 10² |

### Example 5

### Conductive Films Based on Dissolvable Organic Single-Layer Graphene

A single-layer graphene was prepared according to the process of

Example 1. To a three-neck flask were added 0.2 g of single-layer graphene and 300 mL of DMF in which water was removed by distillation. The resultant mixture was ultrasonically treated at 500 W for 40 min to completely disperse. Under nitrogen atmosphere, 0.4 g of methylenediphenyl diisocyanate (MDI) was added. The resultant mixture was stirred for 5 days at the ambient temperature under nitrogen atmosphere and then subject to high speed centrifugation (10,000 r/min) and filtration to obtain a solid. The resultant solid was dried in vacuo so as to obtain MDI functionalized single-layer graphene in the yield of 75%.

To 200 mL of N,N-dimethyl formamide (DMF) was added 0.2 g of MDI modified single-layer graphene. The resultant mixture was ultrasonically treated at 500 W for 40 min to completely disperse. Films were formed on the surface of cleaned glass sheets (5×5 cm) by spin coating, and then placed for 48 h at the ambient temperature. The single-layer graphene films coated on the glass sheets were placed in an airtight device and streamed with hydrazine hydrate (98%, Alfa Aesar) for 24 h to obtain MIDI modified single-layer graphene films reduced by hydrazine dreams. Subsequently, the films was placed in a tubular furnace and calcined for 3 h at 400° C. under nitrogen atmosphere to obtain conductive films based on dissolvable organic single-layer graphene. The thickness of the films was 100 nm and the conductivity was 3×10² S/cm.

### Example 6

### Conductive Films Based on Dissolvable Organic Few-Layer Graphene

To a three-neck flask were added 0.2 g of few-layer graphene and 300 mL of DMF in which water was removed by distillation. The resultant mixture was ultrasonically treated at 500 W for 40 min (KunShan Ultrasonic Instrument Co., Ltd., Model: KQ-500DB) to completely disperse. Under nitrogen atmosphere, 0.3 g of toluene diisocyanate (TDI) was added. The resultant mixture was stirred for 5 days at the ambient temperature under nitrogen atmosphere and subject to high speed centrifugation (10,000 r/min) and filtration to obtain a solid. The resultant solid was dried in vacuo to obtain TDI functionalized few-layer graphene in the yield of 70%.

To 200 mL of acetone was added 0.2 g of TDI modified few-layer graphene. The resultant mixture was ultrasonically treated at 500 W for 40 min (KunShan Ultrasonic Instrument Co., Ltd., Model: KQ-500DB) to completely disperse. Quartz sheets (30×30×3 cm) were immersed in an acetone dispersion for 10 min and placed at the ambient temperature for 12 h after taken out. The quartz sheets were placed in an airtight device and streamed with hydrazine hydrate (80%, Alfa Aesar) for 24 h. Finally, the resultant quartz sheets were calcined at 1100° C. for 1 h in vacuo (10⁻⁵ Torr) to obtain few-layer graphene carbon films, of which the thickness was 10 nm and conductivity was 5×10⁴ S/cm.

### Example 7

### Graphene Conductive Films Based on Polyimide Substrates

A single-layer graphene was prepared according to the process of Example 1. To water was added 2 g of such single-layer graphene. The resultant mixture was ultrasonically treated at 500 W for 30 min to completely disperse.

To increase the wetting property of a polyimide film to water, the polyimide film was firstly pretreated with polyelectrolyte solution. To 0.5 g of polystyrene imine aqueous solution was added 0.5 M sodium chloride aqueous solution to prepare a polystyrene imine solution with final volume of 11.1 ml and concentration of 1.35 mg/ml. To 10 g of sodium polystyrene sulfonate aqueous solution (molecular weight of 100,000) was added a certain amount of sodium chloride aqueous solution to prepare a sodium polystyrene sulfonate solution with final volume of 66.7 ml and concentration of 3 mg/ml. The polyimide film was immersed in the sodium polystyrene sulfonate solution for 20 min and then taken out. The polyimide film was washed with water and dried with hair dryer. The resultant polyimide film was immersed in the polystyrene imine solution for 20 min and then taken out. The polyimide film was washed with water and dried again with hair dryer. The above procedure was repeated for 3 times so as to obtain polyelectrolyte modified polyimide films.

The modified polyimide films were immersed in graphene aqueous solution for 20 min and then placed for 12 h at the ambient temperature after taken out. The resultant modified polyimide films were placed in an airtight device and streamed with hydrazine hydrate (80%, Alfa Aesar) for 24 h. Finally, the resultant modified polyimide films were calcined at 400° C. for 1 h in vacuo (10⁻⁵ Torr) to obtain few-layer graphene carbon films, of which the thickness was 20 nm and conductivity was 4×10² S/cm.

### Example 8

### Graphene Conductive Films Based on Polyester Substrates

A graphene was prepared according to the process of Example 3. To water was added 2 g of the graphene. The resultant mixture was ultrasonically treated at 500 W for 30 min to completely disperse.

To increase the wetting property of a polyester substrate to water, the polyester film was firstly immersed in a concentrated sulfuric acid for 10 min and then taken out. The resultant polyester film was washed with water so as to activate the surface of the polyester film.

The polyester film was immersed in a graphene dispersion for 20 min and placed for 12 h at the ambient temperature after taken out. The polyester films were immersed in a pure hydrazine solution for 24 h so as to obtain reduced single-layer graphene conductive films, of which the thickness was 15 nm and conductivity was 6×10⁻¹ S/cm.

The present application has the following advantages:
1) The single- or few-layer graphene provided in the present invention can dissolve in water or organic solvents and readily realize that the formation of uniform carbon films on the surface of various materials and objects.

The present process is simple and inexpensive and needs small equipment investment and therefore is suitable for products with complex shapes, comparing to the conventional process such as chemical vapor deposition, plasma sputtering, and the like.
2) The carbon films based on graphene have excellent conductivity and the graphene has good conductivity and antistatic effects, comparing with insulating diamond films and amorphous carbon films.
3) Graphene has the best mechanical properties in the known materials such that the carbon films provided in the present invention have higher strength and modulus. Therefore, the carbon films can be used in special conditions such as construction, machines, aeronautics and astronautics and the like.
4) As graphene has excellent thermal conductivity, the carbon films provided in the present invention have advantages such as good heat of dissipation, it is expected that the carbon films can be used in the fields of precision instrument, microelectronics and the like.
5) When the thickness of the graphene carbon films is less than 10 nm, the graphene carbon films have excellent transmittance such that transparent conductive films can be obtained.

In view of the above advantages, the carbon films based on single- or few-layer graphene of the present invention have good prospects in the conventional fields of machines, construction, medical care and the like as well as in the high-technology fields of precision instrument, microelectronics and the like.

1. A process for preparing a conductive film comprising:
coating a solution comprising functionalized graphene on the surface of a substrate to form a film; and
chemically reducing and/or calcining the film which is coated on the substrate and obtained in step 1).

2. The process of claim 1, wherein the functionalized graphene is prepared with graphite as raw materials by chemical oxidation.

3. The process of claim 1, wherein the functionalized graphene is prepared by reacting a chemically oxidized graphene with an organic functionalized reagent, wherein the organic functionalized reagent is an isocyanate compound.

4. The process of claim 3, wherein the isocyanate compound is selected from a mono-isocyanate compound or a diisocyanate compound, in which the mono-isocyanate compound is selected from phenyl isocyanate, tert-butyl isocyanate, cyclohexane isocyanate, hexane isocyanate, cyanophenyl isocyanate, acetylphenyl isocyanate, or isocyanatobenzene sulfonate azide, and the diisocyanate compound is selected from toluene diisocyanate, methylenediphenyl diisocyanate, 1,6-hexamethylene diisocyanate, isophorone diisocyanate, or hydrogenated methylenediphenyl diisocyanate.

5. The process of claim 3, wherein the solvent used in the solution is selected from water, acetone, N,N-dimethyl formamide (DMF), ethanol, benzene, dichlorobenzene, tetrahydrofuran and/or acetonitrile.

6. The process of any one of claim 1, wherein the solution of functionalized graphene has a concentration of 0.1 to 10 mg/mL.

7. The process of any one of claim 1, wherein the coating is immersing, spin coating, spraying or casting.

8. The process of any one of claim 1, wherein the substrate is selected from steel, glass, ceramics, quartz, carbon materials, silicon materials and/or organic materials.

9. The process of claim 8, wherein the organic material is selected from polyurethane, polyacrylate, polyester, polyamide, ABS, polyolefin, polycarbonate, polyvinyl chloride, polyimide, epoxy resin, phenolic resin and/or rubber.

10. The process of claim 8, wherein if the substrate is an organic material and the solution comprising functionalized graphene is an aqueous solution, the process further comprises, before the step 1), activating the surface of the organic material and strengthening the hydrophilicity of the surface of the organic material, preferably the activating step is immersing the substrate in a concentrated sulfuric acid or coating polystyrene imine and sodium polystyrene sulfonate on the surface of the substrate.

11. The process of claim 1, wherein the chemical reduction and calcination are used alone or in combination with each other.

12. The process of claim 1, wherein a reducing agent used in the chemical reduction is hydrazine, hydrazine hydrate, dimethylhydrazine and/or borohydride such as sodium borohydride and potassium borohydride.

13. The process of claim 1, wherein the chemical reduction is streaming with hydrazine hydrate.

14. The process of any one of claim 1, wherein the calcination is carried out in vacuo.

15. The process of claim 1, wherein the calcination is carried out under inert gas atmosphere such as nitrogen, argon, helium and the like.

16. A conductive film prepared with the process of claim 1.

17. A process for changing the properties of the surface of a substrate, comprising forming a conductive film on the surface of the substrate with the process of claim 1.
